(19) United States
(12) Patent Application Publication
(10) Pub. No.: US 2003/0111586 A1
(43) Pub. Date: Jun. 19, 2003

(54) Molding apparatus

(76) Inventor: Gary A. Durivage, Graytown, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/318,641

(22) Filed: Dec. 13, 2002

Related U.S. Application Data
(60) Provisional application No. 60/340,552, filed on Dec. 14, 2001.

(51) Int. Cl. B29C 49/42

(52) U.S. Cl. 249/63; 425/526; 425/522; 249/79

(57) ABSTRACT

A rotary insert for a mold used in a molding die.

### CROSS-REFERENCE TO RELATED APPLICATION

This application claims the benefit of U.S. provisional patent application Serial No. 60/340,552, filed Dec. 14, 2001.

### BACKGROUND OF THE INVENTION

1. Field of the Invention

The present invention relates to molding or blow molding apparatus and more specifically to a new and improved design for a rotary insert for a mold used in a molding or blow molding system.

2. Description of the Prior Art

The final shape of an article to be molded is determinative of the type of molding system which can be used to produce the article. Oftentimes, due to economics and production requirements it would be desirable to blow mold an article, but due to the particular shape or configuration of the article, the shape of the necessary insert precludes molding or blow molding because the insert cannot be efficiently removed from the produced article.

There have been many attempts to design inserts which can be satisfactorily removed from the finished article. Such insert designs include multi-part inserts, and inserts designed to slide into and out of operative position. While such inserts have produced satisfactory production articles, it has been found that the space requirements for the sliding components and the associated operating mechanisms were excessive.

### SUMMARY OF THE INVENTION

An object of the present invention is to produce an insert for a molding or blow molding apparatus which can be used to produce plastic articles wherein the insert may be rotatingly moved to facilitate the exiting thereof from the molded article.

The above object and advantages of the invention can be realized by a molding or blow molding apparatus including an insert for a molding or blow molding die comprising a main body; at least one rotary insert; means for pivotally interconnecting the rotary insert to the main body; and means for actuating the rotary insert to effect relative rotational movement between the rotary insert and the main body.

### BRIEF DESCRIPTION OF THE DRAWINGS

Other objects and advantages of the invention will become readily apparent to those skilled in the art from reading the following detailed description of the invention when considered in the light of the accompanying figures, in which:

FIG. 1 is a perspective view of the top of an insert for a blow-molding die incorporating the features of the invention; and

FIG. 2 is a perspective view of the bottom of the insert illustrated in FIG. 1.

### DETAILED DESCRIPTION OF THE PREFERRED EMBODIMENT

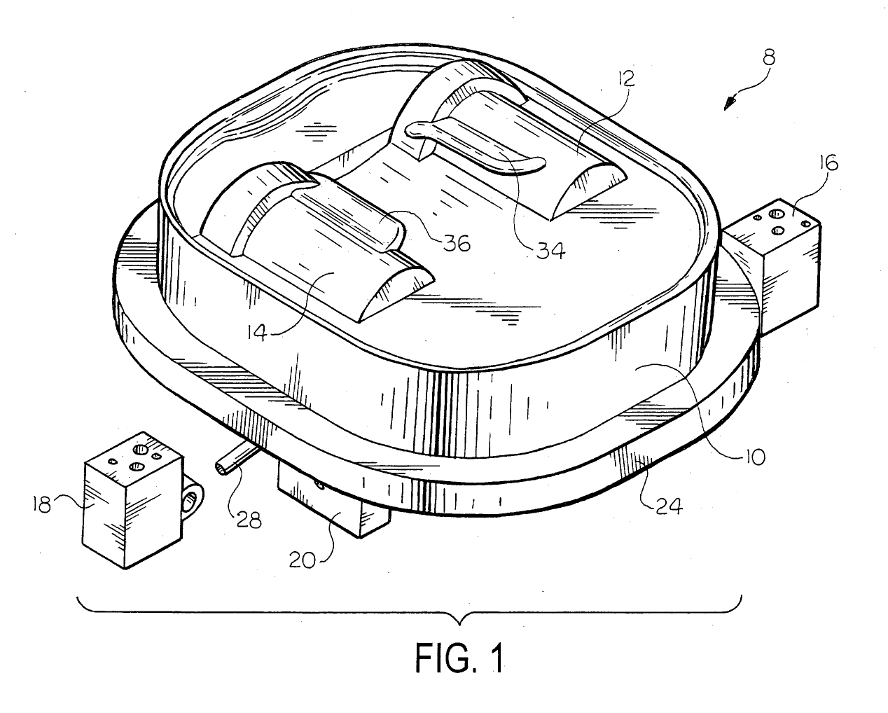

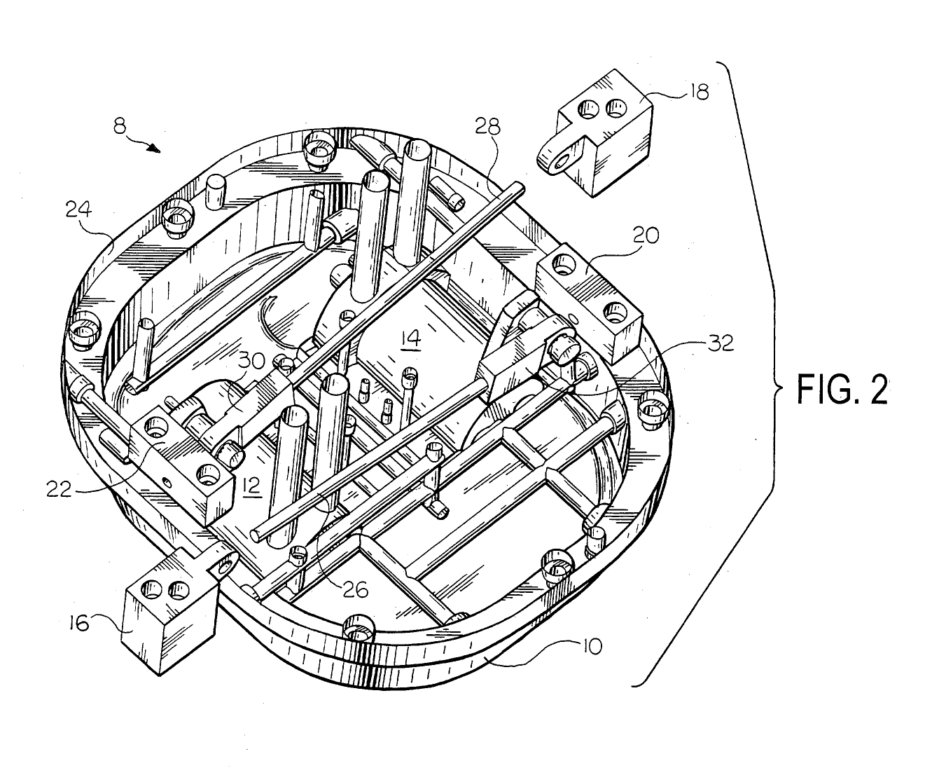

Referring to FIGS. 1 and 2, there is illustrated an insert for a molding or blow molding die incorporating the novel features of the invention.

The rotary insert assembly incorporating the features of the invention is generally indicated by reference numeral 8. The insert assembly 8 includes a main body 10 containing an upper surface portion having apertures formed therein through which a portion of each of a pair of similar rotatably mounted insert members 12 and 14 is allowed to project.

As clearly illustrated, the rotary inserts 12 and 14 are generally cylindrical in shape and are typically mounted to rotate about the axes of individual respective pivot pins, for example. Rotation of the inserts 12 and 14 is effected through cylinder mounting blocks 18 and 16, which are pivotally secured to the inserts 12 and 14 through respective linkages 28 and 26. It will be noted that the innermost ends of the linkages 28 and 26 are provided with associated pivotal connectors 30 and 32.

Heat energy may be removed from the system through a matrix of fluid conduits as schematically illustrated in FIG. 2.

The insert assembly 8 may typically be secured within a suitable mold by a plurality of spaced apart mounting points positioned internally of a circumferentially extending skirt 24 which is formed to depend from the main body 10, as illustrated.

The rotary insert assembly 8 is typically back mounted into a mold. The rotary insert 12 is actuated to an open-position by retracting the cylinder that is operatively coupled to the cylinder mounting block 18. When the cylinder is actuated, the rotary insert 12 is rotated, the insert is caused to be rotated about its axis utilizing an associate pivot pin arrangement for rotatably supporting the insert. The cylinder mounting block 18 is operatively coupled to the operating cylinder. The operating cylinder is operatively coupled to the linkage 28 and the pivotal connector 30 of the insert 12 which allows the needed pivoting motion to effect the desired rotation of the insert 12. Self-lubricating bushing means may be employed with the linkage to reduce friction. When the cylinder that is mounted to the mounting block 18 is retracted, the insert linkage 28 will cause the insert 12 to rotate to an open-position, for example. When the cylinder that is mounted to the mounting block 18 is extended the insert linkage 28 will cause the insert 12 to rotate to the closed-position. The rotary insert 12 may have cavity contour formed on the outer surface thereof, or whatever other configuration deemed to assist in the exiting of the molded part from the mold.

A positive stop member 22 is mounted in the main body 10 to physically limit the movement of the linkage. An adjustable screw and lock nut may be employed to allow the stop member 22 to be adjusted, as needed.

The rotary insert 12 includes a removable tip member 34. The tip member 34 may be removable for manufacturing purposes; ease of assembly; as well as the ease of modifications for sizing modifications. When the rotary insert 12 has been rotated, the tip member 34 is in an open-position resulting in a non die-lock condition allowing for pulling material into the draw areas. When the rotary insert 12 has been rotated into a closed position, the final cavity shape will be created. When the rotary insert 12 has been rotated in an opposite direction, the tip member 34 will effect a pushing action to assist in the ejection of the molded part.

The rotary insert 12 may be water-cooled. Rotary water conduit means are used to allow the water to flow in and out of the assembly resulting in a cooling action. When the rotary insert 12 is in the closed-position, the rotary water-in cooling conduit and a rotary water-out cooling conduit are in a vertical fashion. When the rotary insert 12 is in the open-position, the rotary water-in cooling conduit and the rotary water-out cooling conduit are on an angled fashion. The rotary insert 12 may have a pressure “welsh” plug on the exposed end due to a water cooling line being exposed in the open-position. The “welsh” plug is typically machined flush with the edge of the rotary insert 12 to eliminate the chance of material getting caught when the rotary insert 12 as it is rotated from the open-position to the closed-position.

Sufficient clearance is provided in the main body 10 of the insert for movement of the rotary water-in cooling conduit from a closed-position and movement of the rotary water-out cooling conduit from a closed-position and the associated linkage 28 and pivotal connector 30.

The rotary insert 14 is actuated to an open-position by retracting the cylinder that is operatively coupled to the cylinder mounting block 16. When the cylinder is actuated, the rotary insert 14 is rotated, the insert is caused to be rotated about its axis utilizing an associate pivot pin arrangement for rotatably supporting the insert. The cylinder mounting block 16 is operatively coupled to the operating cylinder. The operating cylinder is operatively coupled to the linkage 26 and the pivotal connector 32 of the insert 14 which allows the needed pivoting motion to effect the desired rotation of the insert 14. Self-lubricating bushing means may be employed with the linkage to reduce friction. When the cylinder that is mounted to the mounting block 16 is retracted, the insert linkage 26 will cause the insert 14 to rotate to an open-position, for example. When the cylinder that is mounted to the mounting block 16 is extended the insert linkage 26 will cause the insert 14 to rotate to the closed-position. The rotary insert 14 may have cavity contour formed on the outer surface thereof, or whatever other configuration deemed to assist in the exiting of the molded part from the mold.

A positive stop member 20 is mounted in the main body 10 to physically limit the movement of the linkage. An adjustable screw and lock nut may be employed to allow the stop member 20 to be adjusted, as needed.

The rotary insert 14 includes a removable tip member 36. The tip member 36 may be removable for manufacturing purposes; ease of assembly; as well as the ease of modifications for sizing modifications. When the rotary insert 14 has been rotated, the tip member 36 is in an open-position resulting in a non die-lock condition allowing for pulling material into the draw areas. When the rotary insert 14 has been rotated into a closed position, the final cavity shape will be created. When the rotary insert 14 has been rotated in an opposite direction, the tip member 36 will effect a pushing action to assist in the ejection of the molded part.

The rotary insert 14 may be water-cooled. Rotary water conduit means are used to allow the water to flow in and out of the assembly resulting in a cooling action. When the rotary insert 14 is in the closed-position, the rotary water-in cooling conduit and a rotary water-out cooling conduit are in a vertical fashion. When the rotary insert 14 is in the open-position, the rotary water-in cooling conduit and the rotary water-out cooling conduit are on an angled fashion. The rotary insert 14 may have a pressure “welsh” plug on the exposed end due to a water cooling line being exposed in the open-position. The “welsh” plug is typically machined flush with the edge of the rotary insert 14 to eliminate the chance of material getting caught when the rotary insert 14 as it is rotated from the open-position to the closed-position.

Sufficient clearance is provided in the main body 10 of the insert for movement of the rotary water-in cooling conduit from a closed-position and movement of the rotary water-out cooling conduit from a closed-position and the associated linkage 26 and pivotal connector 32.

It will be understood that the rotary inserts 12 and 14 may be fabricated of aluminum, stainless steel, tool steels, specialty materials or copper alloys. The outer surfaces of the inserts may be provided with a coating to promote lubricity as well as wear resistance.

In accordance with the provisions of the patent statutes, the present invention has been described in what is considered to represent its preferred embodiment. However, it should be understood that the invention can be practiced otherwise than as specifically illustrated and described without departing from its spirit or scope.

What is claimed is:

1. An insert for a molding die comprising:
a main body;
at least one rotary insert;
means for pivotally interconnecting said rotary insert to said main body; and
means for actuating said rotary insert to effect relative rotational movement between said rotary insert and said main body.

2. An insert for a molding die as defined in claim 1 including means for cooling said main body.

3. An insert for a molding die as defined in claim 1 wherein said means for actuating said rotary insert includes a pressure fluid actuated cylinder.

4. An insert for a molding die as defined in claim 1 wherein said means for actuating said rotary insert includes a pneumatically actuated cylinder.

5. An insert for a molding die comprising:
a main body;
a pair of spaced apart rotary inserts;
means for rotatingly mounting said inserts to said main body; and
actuating means connected to said inserts for effecting rotational movement between said inserts and said main body.

6. An insert for a molding die as defined in claim 5 wherein said main body is provided with a pair of spaced apart apertures, and a portion of each of said inserts extends through respective ones of said apertures.

7. An insert for a molding die as defined in claim 5 wherein said rotary inserts include outwardly extending arms which cooperate to assist in exiting a blow molded part therefrom.

8. An insert for a molding die as defined in claim 5 wherein said rotary inserts are provided with cooling means.

9. An insert for a molding die as defined in claim 8 wherein said cooling means include internal formed conduits.
